(19) United States
(12) Patent Application Publication
(10) Pub. No.: US 2013/0010241 A1
(43) Pub. Date: Jan. 10, 2013

(54) LIQUID CRYSTAL DISPLAY APPARATUS

(76) Inventors: Hung-Lung Hou, Shenzhen (CN); Chengming He, Shenzhen (CN)

(21) Appl. No.: 13/319,518

(22) PCT Filed: Sep. 1, 2011
(86) PCT No.: PCT/CN2011/079219

§ 371 Date: Nov. 8, 2011

(30) Foreign Application Priority Data
Jul. 4, 2011 (CN) 201110185531.9

(51) Int. Cl. G02F 1/1335

(52) U.S. Cl. 349/110; 349/117; 349/119

(57) ABSTRACT

The present invention provides a liquid crystal display (LCD) apparatus. The LCD apparatus comprises a TFT-LCD module and a corresponding phase retarder, and a light adjustment plate is disposed between the TFT-LCD module and the phase retarder and configured to reduce an optical path difference of a light emitted from the phase retarder. Alternatively, the TFT-LCD module comprises a light adjustment plate configured to reduce the optical path difference of the light emitted from the phase retarder. The present invention can mitigate crosstalk when viewing 3D images.

### FIELD OF THE INVENTION

The present invention relates to a field of a liquid crystal display (LCD) technology, and more particularly to an LCD apparatus capable of reducing crosstalk between pixels and effects on two-dimensional (2D) images of the display.

### BACKGROUND OF THE INVENTION

With the development of the three-dimensional (3D) display technology, the requirement for using a 3D display to view 3D images is higher and higher. Referring to FIG. 1, FIG. 1 is a cross-sectional view of a normal 3D display cooperated with glasses and comprising a thin film transistor (TFT)-LCD module and a phase retarder. Pixels signals of the 3D display are alternately displayed from above to below for a viewer's a left eye and a right eye. Referring to FIG. 2, the signals of the display are displayed in a manner of rows and received by the viewer's eyes.

The phase retarder is bonded to a front side of the TFT-LCD module. According to the displayed pixel signals of the display, the phase retarder can provide different phase retardation for the left and right eyes, respectively. Therefore, the signals with the same vertical polarization state emitted from the TFT-LCD module are transformed into different polarized lights for the left and right eyes. Referring to FIG. 1, when the polarization state of the light emitted from the TFT-LCD module is the vertical polarization state, the pixel signals for right eye are transformed into horizontally polarized lights by a half-wave (λ/2) phase retarder, and the pixel signals for left eye remain the vertical polarization state by using a zero-wave phase plate, and the pixel signals are then separated for the left and right eyes by using a polarizer glasses.

However, there is a defect exiting in the design of FIG. 1. That is, viewing angle thereof is limited to ±θ1. When the viewing angle exceeds ±θ1, the pixel signals for left eye may pass through the λ/2 phase retarder, and the pixel signals for right eye may pass through the zero-wave phase plate. Therefore, the pixel signals for right eye which pass through the zero-wave phase plate further pass through a left polarizer glass which is used to receive the pixel signals for left eye, and the pixel signals for left eye which pass through the λ/2 phase retarder further pass through a right polarizer glass which is used to receive the pixel signals for right eye, and then crosstalk arises. That is, a traction phenomena appears on a background of a display frame with high contrast.

FIG. 3 shows a method for improving crosstalk of the LCD which includes a black matrix between the λ/2 phase retarder and the zero-wave phase plate of the phase retarder. A width a of the λ/2 phase retarder and the zero-wave phase plate is reduced to a width b, so as to widen a angle for allowing the pixel signal to pass the phase retarder, hence increasing the viewing angle without crosstalk. However, when using the LCD to view 2D images, the brightness of the 2D images displayed by the LCD is reduced by the black matrix.

### SUMMARY OF THE INVENTION

A primary object of the present invention is to provide an LCD apparatus, so as to solve the problem that crosstalk easily appears when viewing the 3D images, thereby deteriorating the display quality, and the brightness of the 2D images is reduced.

The present invention can be achieved as below.

The present invention provides a liquid crystal display (LCD) apparatus comprising a thin film transistor (TFT)-LCD module and a corresponding phase retarder, wherein a light adjustment plate is disposed between the TFT-LCD module and the phase retarder and configured to reduce an optical path difference of a light emitted from the phase retarder, and a refractive index of the light adjustment plate is larger than a refractive index of a liquid crystal layer of the TFT-LCD module, and a thickness and the refractive index of the light adjustment plate are varied for reducing the optical path difference of the light emitted from the phase retarder, and the refractive index of the light adjustment plate is in the range of 1.5 to 1.7, and the light adjustment plate includes a black matrix for reducing crosstalk, and the phase retarder comprises an assembly of a zero-wave phase plate and a half-wave (λ/2) phase retarder, or an assembly of quarter-wave (λ/4) phase retarder having slow-axis angles of 45 degrees and 135 degrees.

The present invention further provides an LCD apparatus comprising a TFT-LCD module and a corresponding phase retarder, wherein a light adjustment plate is disposed between the TFT-LCD module and the phase retarder and configured to reduce an optical path difference of a light emitted from the phase retarder.

In one embodiment of the present invention, a refractive index of the light adjustment plate is larger than a refractive index of a liquid crystal layer of the TFT-LCD module.

In one embodiment of the present invention, the optical path difference of the light emitted from the phase retarder is reduced by increasing a thickness of the light adjustment plate.

In one embodiment of the present invention, the optical path difference of the light emitted from the phase retarder is reduced by increasing a refractive index of the light adjustment plate.

In one embodiment of the present invention, a thickness and a refractive index of the light adjustment plate are varied for reducing the optical path difference of the light emitted from the phase retarder.

In one embodiment of the present invention, the refractive index of the light adjustment plate is in the range of 1.5 to 1.7.

In one embodiment of the present invention, the light adjustment plate includes a black matrix for reducing crosstalk.

In one embodiment of the present invention, the phase retarder comprises an assembly of a zero-wave phase plate and a λ/2 phase retarder.

In one embodiment of the present invention, the phase retarder comprises an assembly of λ/4 phase retarder having slow-axis angles of 45 degrees and 135 degrees.

The conventional LCD has the problem that crosstalk easily appears when viewing the 3D images, thereby deteriorating the display quality, and the brightness of the 2D images is reduced. In comparison with the conventional LCD, the LCD apparatus comprises the light adjustment plate disposed between the TFT-LCD module and the phase retarder, and configured to reduce the optical path difference of the light emitted from the phase retarder, so as to reduce crosstalk when viewing the 3D images, and to mitigate the problem that the brightness of the 2D images is reduced.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a structural diagram showing a conventional LCD;

FIG. 2 is a schematic diagram showing panel signals of the conventional LCD;

FIG. 3 is a structural diagram showing the conventional LCD including a black matrix on a phase retarder; and

FIG. 4 is a schematic diagram showing an LCD apparatus according to a preferred embodiment of the present invention.

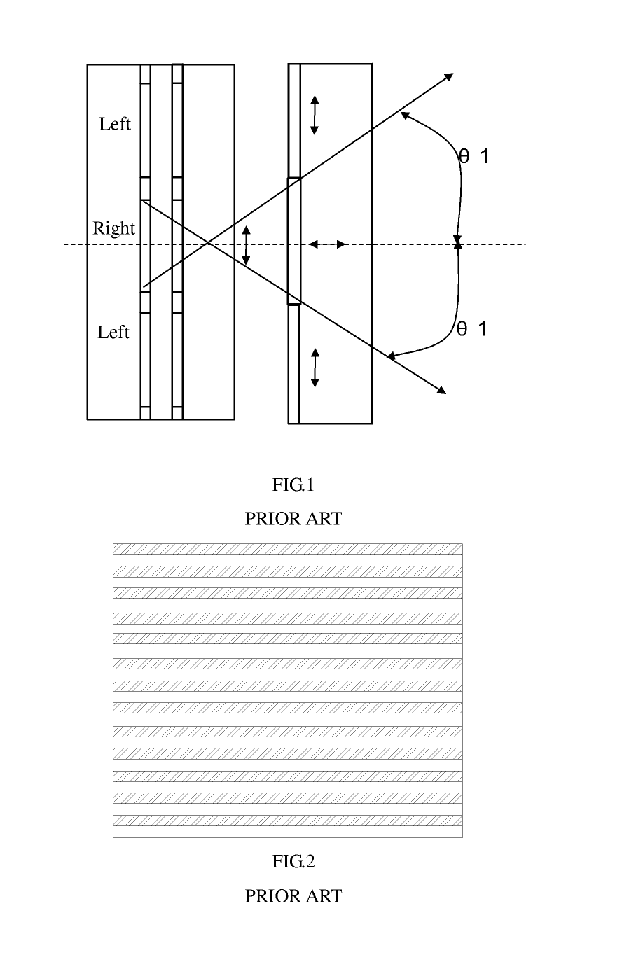

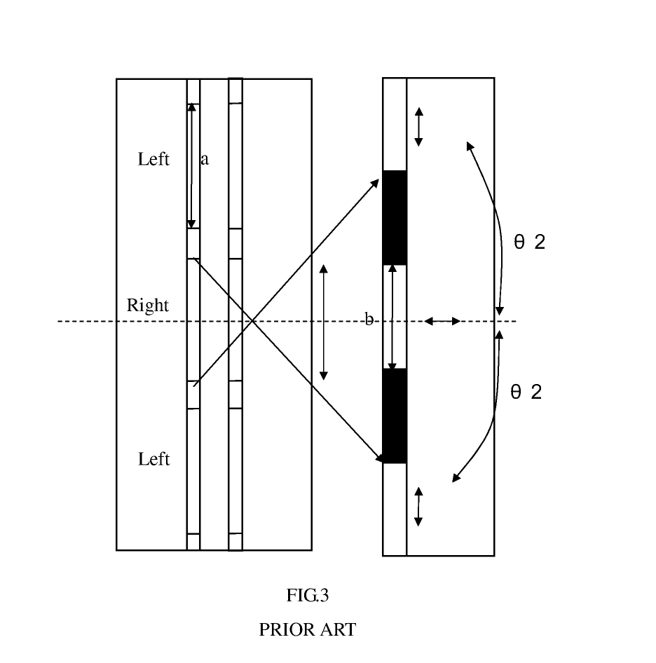

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

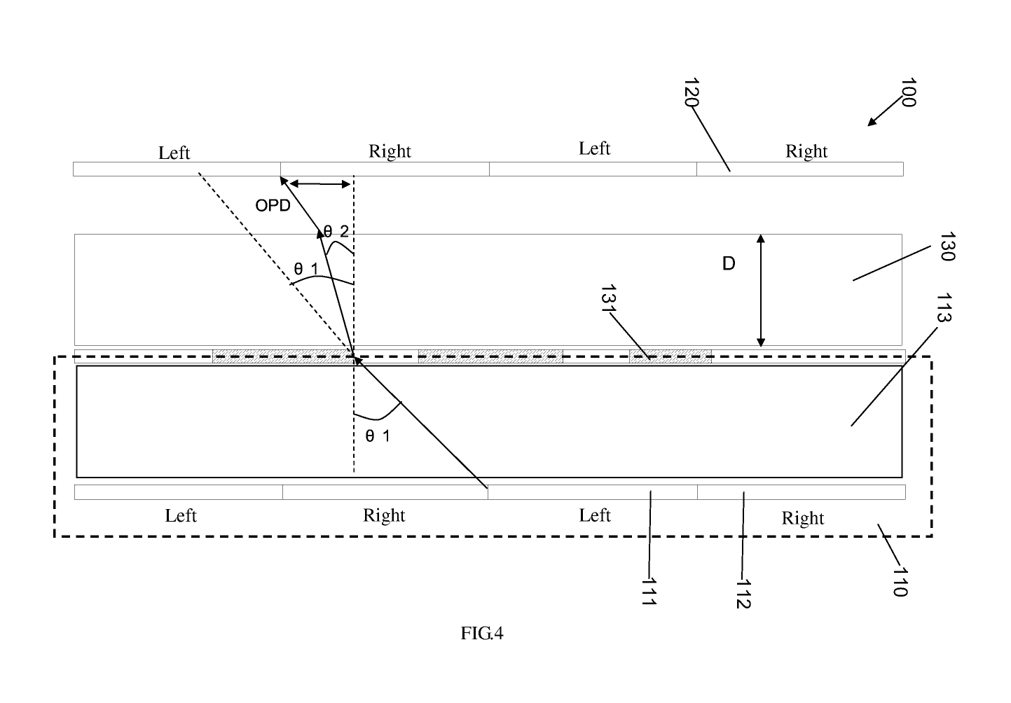

In a preferred embodiment of the present invention, FIG. 4 is structural diagram showing an LCD apparatus according to the preferred embodiment of the present invention. The LCD apparatus 100 comprises a TFT-LCD module 110 and a corresponding phase retarder 120. The TFT-LCD module 110 comprises pixels 111 for left eye signals and pixels 112 for right eye signals. The pixels 111 for left eye signals cooperate with a phase retarder 120 to emit polarized signals, and the pixels 112 for right eye signals cooperate with another phase retarder 120 to emit polarized signals. The LCD apparatus 100 of the present invention further comprises a light adjustment plate 130 disposed between the TFT-LCD module 110 and the phase retarder 120 and configured to reduce an optical path difference of a light emitted from the phase retarder 120. When using the LCD apparatus 100 of the present invention, the light adjustment plate 130 can reduce the optical path difference of the light emitted from the phase retarder 120, thus reducing a light output area of the left or right eye pixels on the phase retarder 120. Therefore, it can be mitigated that the pixel signals for left eye pass through the λ/2 phase retarder to form horizontal left eye signals (should be vertical left eye signals), and similarly, it can be also mitigated that the pixel signals for right eye pass through the zero-wave phase plate to form vertical right eye signals (should be horizontal right eye signals). In this manner, crosstalk can be prevented.

In FIG. 4 which is the structural diagram showing the LCD apparatus according to the preferred embodiment of the present invention, a refractive index of the light adjustment plate 130 is larger than a refractive index of a liquid crystal layer 113 of the TFT-LCD module 110. When the refractive index of the light adjustment plate 130 is larger than the refractive index of the liquid crystal layer 113 of the TFT-LCD module 110, a refractive angle of light rays emitted from the liquid crystal layer 113 to the light adjustment plate 130 is less than an incident angle of the light rays emitted from the liquid crystal layer 113 to the light adjustment plate 130, thereby reducing the optical path difference of the light emitted from the phase retarder 120. Thus, the light output range can be reduced for preventing crosstalk.

There are some manners for altering parameters of the light adjustment plate 130 of the LCD apparatus 100 of the present invention, so as to reduce the optical path difference of the light emitted from the phase retarder 120.

In a first manner, a thickness of the light adjustment plate 130 is increased, so as to reduce the optical path difference of the light emitted from the phase retarder 120. When a material of the light adjustment plate 130 is determined, the refractive index of the light adjustment plate 130 is limited. The refractive index of the light adjustment plate 130 may be larger than the refractive index of the liquid crystal layer 113 of the TFT-LCD module 110, and the thickness of the light adjustment plate 130 is increased, thus reducing the optical path difference of the light emitted from the phase retarder 120. The thickness of the light adjustment plate 130 is increased, i.e. the distance of light rays in air and between the light adjustment plate 130 and the phase retarder 120. Accordingly, in one pixel, the light output range on the phase retarder 120 can be reduced for preventing crosstalk. In this manner, any material of the light adjustment plate 130 is allowed. However, when the refractive index of the light adjustment plate 130 is less, the light adjustment plate 130 is required to be thicker for preventing crosstalk, thereby increasing a weight of the LCD apparatus 100.

In a second manner, the refractive index of the light adjustment plate 130 is increased, so as to reduce the optical path difference of the light emitted from the phase retarder 120. When altering the material of the light adjustment plate 130, the refractive index of the light adjustment plate 130 can be increased for reducing the optical path difference of the light emitted from the phase retarder 120. Accordingly, in one pixel, the light output range on the phase retarder 120 can be reduced for preventing crosstalk. In this manner, by altering the material of the light adjustment plate 130, the structure of the LCD apparatus 100 can be invariable for improving crosstalk.

In a third manner, the thickness and the refractive index of the light adjustment plate 130 can be varied at the same time, so as to reduce the optical path difference of the light emitted from the phase retarder 120. When altering the thickness and the refractive index of the light adjustment plate 130, the integrated parameters are considered. For example, when a material of high refractive index is used, the thickness of the light adjustment plate 130 can be reduced for improving crosstalk and enhancing display quality (for example, too much refraction of the light adjustment plate 130 may deform the displayed frame, hence affecting display quality). When a material of lower refractive index is used, the thickness of the light adjustment plate 130 can be increased for improving crosstalk.

In FIG. 4 which is the structural diagram showing the LCD apparatus according to the preferred embodiment of the present invention, the light adjustment plate 130 further comprises a black matrix 131 for improving crosstalk. The black matrix 131 is disposed on the light adjustment plate 130 of the LC panel. For separating the RGB pixels, the black matrix 131 is in the shape of a grid or stripes. The light adjustment plate 130 can prevent the TFT-LCD module 110 from an interference of an external light source. The material of the black matrix 131 may be Cr, low reflective Cr or resin material. An area of the black matrix 131 of the LCD apparatus 100 of the present invention can be reduced by using the light adjustment plate 130, so as to improve crosstalk and ensure the aperture ratio of the LC panel. The cooperation of the black matrix 131 and the light adjustment plate 130 can achieve the best effect of preventing crosstalk and ensuring the aperture ratio of the LC panel.

In the preferred embodiment, the phase retarder 120 may comprise an assembly of the zero-wave phase plate and the λ/2 phase retarder, or an assembly of quarter-wave (λ/4) phase retarders having slow-axis angles of 45 degrees and 135 degrees. When using the assembly of the zero-wave phase plate and the λ/2 phase retarder, glasses which have a horizontal polarization absorption glass at one side thereof and a vertical polarization absorption glass at another side thereof are required for 3D display effect. When using the assembly of the λ/4 phase retarders having slow-axis angles of 45 degrees and 135 degrees, glasses which have a left-handed circular polarization absorption glass at one side thereof and a right-handed circular polarization absorption glass at another side thereof are required for 3D display effect. The user can choose a suitable assembly for forming polarized signals for left or right eye according to real requirements.

A working process of the LCD apparatus of the present invention is described cooperated with a structural diagram according to the preferred embodiment shown in FIG. 4.

The LCD apparatus 100 comprises the TFT-LCD module 110, the corresponding phase retarder 120 and the light adjustment plate 130. The TFT-LCD module 110 comprises the pixels 111 for left eye signals, the pixels 112 for right eye signals and the liquid crystal layer 113. The black matrix 131 is disposed on the light adjustment plate 130. Referring to FIG. 4, the light rays emitted from lamps pass through the pixels 111 for left eye signals, the liquid crystal layer 113, the black matrix 131, the light adjustment plate 130 and the phase retarder 120 in sequence. The refractive index n2 of the light adjustment plate 130 is larger than the refractive index n1 of the liquid crystal layer 113 of the TFT-LCD module 110, and the incident angle of the light rays entering the light adjustment plate 130 is θ1, and the refractive angle of light rays passing through an interface of the light adjustment plate 130 is θ2. According to Snell's Law: n1*sin(θ1)=n2*sin(θ2), a reduction [D*tan(θ1)-D*tan(θ2)] of the optical path difference (OPD) is obtained, wherein D is the thickness of the light adjustment plate 130. When n2 is getting larger, θ2 is reduced, and the OPD is also reduced, thereby preventing the light rays from entering a wrong range for improving crosstalk. As shown in FIG. 4, the reduction of the OPD can be controlled by altering the thickness D or refractive index of the light adjustment plate 130. For example, the refractive index n1 of the liquid crystal layer 113 is 1.5, and the thickness D of the light adjustment plate 130 is 700 um, and the incident angle θ1 is 30 degrees, and the refractive index n2 of the light adjustment plate 130 is 1.7. Thus, the reduction of the OPD is 404 um-344 um=60 um. Normally, the refractive index of the liquid crystal layer 113 is less than 1.5, and the refractive index of the light adjustment plate 130 is in the range of 1.5 to 1.7.

By altering the thickness and the refractive index (the refractive index between the liquid crystal layer 113 and the phase retarder 120) of the light adjustment plate 130, the LCD apparatus 100 of the present invention can reduce the incident angle and OPD of the light rays, so as to prevent the light rays from entering a wrong range of the phase retarder 120 for improving crosstalk. In that manner, the area of the black matrix can be reduced for prevent crosstalk in 3D displaying and enhancing the aperture of the LC panel.

In another embodiment of the present invention, the light adjustment plate 130 may be disposed in the TFT-LCD module 110 for reducing the optical path difference of the light emitted from the phase retarder 120. At this time, the light adjustment plate 130 may be one of two substrates of the TFT-LCD module 110. For example, the light adjustment plate 130 may be a glass substrate having color filters (CF). Therefore, similar to the above-mentioned description, the parameters, such as the thickness or the refractive index, of the light adjustment plate 130 of the TFT-LCD module 110 can be varied for reducing the optical path difference of the light emitted from the phase retarder 120.

The present invention has been described with a preferred embodiment thereof and it is understood that many changes and modifications to the described embodiment can be carried out without departing from the scope and the spirit of the invention that is intended to be limited only by the appended claims.

1. A liquid crystal display (LCD) apparatus comprising a thin film transistor (TFT)-LCD module and a corresponding phase retarder, characterized in that: a light adjustment plate is disposed between the TFT-LCD module and the phase retarder and configured to reduce an optical path difference of a light emitted from the phase retarder, and a refractive index of the light adjustment plate is larger than a refractive index of a liquid crystal layer of the TFT-LCD module, and a thickness and the refractive index of the light adjustment plate are varied for reducing the optical path difference of the light emitted from the phase retarder, and the refractive index of the light adjustment plate is in the range of 1.5 to 1.7, and the light adjustment plate includes a black matrix for reducing crosstalk, and the phase retarder comprises an assembly of a zero-wave phase plate and a half-wave (λ/2) phase retarder, or an assembly of quarter-wave (λ/4) phase retarder having slow-axis angles of 45 degrees and 135 degrees.

2. An LCD apparatus comprising a TFT-LCD module and a corresponding phase retarder, characterized in that: a light adjustment plate is disposed between the TFT-LCD module and the phase retarder and configured to reduce an optical path difference of a light emitted from the phase retarder.

3. The LCD apparatus according to claim 2, characterized in that: a refractive index of the light adjustment plate is larger than a refractive index of a liquid crystal layer of the TFT-LCD module.

4. The LCD apparatus according to claim 3, characterized in that: the optical path difference of the light emitted from the phase retarder is reduced by increasing a thickness of the light adjustment plate.

5. The LCD apparatus according to claim 3, characterized in that: the optical path difference of the light emitted from the phase retarder is reduced by increasing a refractive index of the light adjustment plate.

6. The LCD apparatus according to claim 3, characterized in that: a thickness and a refractive index of the light adjustment plate are varied for reducing the optical path difference of the light emitted from the phase retarder.

7. The LCD apparatus according to claim 4, characterized in that: the refractive index of the light adjustment plate is in the range of 1.5 to 1.7.

8. The LCD apparatus according to claim 5, characterized in that: the refractive index of the light adjustment plate is in the range of 1.5 to 1.7.

9. The LCD apparatus according to claim 6, characterized in that: the refractive index of the light adjustment plate is in the range of 1.5 to 1.7.

10. The LCD apparatus according to claim 4, characterized in that: the light adjustment plate includes a black matrix for reducing crosstalk.

11. The LCD apparatus according to claim 5, characterized in that: the light adjustment plate includes a black matrix for reducing crosstalk.

12. The LCD apparatus according to claim 6, characterized in that: the light adjustment plate includes a black matrix for reducing crosstalk.

13. The LCD apparatus according to claim 4, characterized in that: the phase retarder comprises an assembly of a zero-wave phase plate and a λ/2 phase retarder, or an assembly of λ/4 phase retarder having slow-axis angles of 45 degrees and 135 degrees.

14. The LCD apparatus according to claim 5, characterized in that: the phase retarder comprises an assembly of a zero-wave phase plate and a λ/2 phase retarder, or an assembly of λ/4 phase retarder having slow-axis angles of 45 degrees and 135 degrees.

15. The LCD apparatus according to claim 6, characterized in that: the phase retarder comprises an assembly of a zero-wave phase plate and a λ/2 phase retarder, or an assembly of λ/4 phase retarder having slow-axis angles of 45 degrees and 135 degrees.

16. A LCD apparatus comprising a TFT-LCD module and a corresponding phase retarder disposed on the TFT-LCD module, characterized in that: the TFT-LCD module comprises a light adjustment plate configured to reduce an optical path difference of a light emitted from the phase retarder.
